(19) United States
(12) Patent Application Publication
(10) Pub. No.: US 2022/0162377 A1
(43) Pub. Date: May 26, 2022

(54) FOAM SHEET, PRODUCT, AND METHOD FOR PRODUCING FOAM SHEET

(71) Applicants: Shizuka Hashida, Kanagawa (JP); Taichi Nemoto, Shizuoka (JP); Yoshimitsu Kumai, Kanagawa (JP)

(72) Inventors: Shizuka Hashida, Kanagawa (JP); Taichi Nemoto, Shizuoka (JP); Yoshimitsu Kumai, Kanagawa (JP)

(73) Assignee: Ricoh Company, Ltd., Tokyo (JP)

(21) Appl. No.: 17/530,593

(22) Filed: Nov. 19, 2021

(30) Foreign Application Priority Data
Nov. 24, 2020 (JP) 2020-194334

(51) Int. Cl. C08G 63/06; C08K 3/36; C08J 9/00; C08J 9/12

(52) U.S. Cl. CPC C08G 63/06; C08K 3/36; C08J 2367/04; C08J 9/122; C08J 2203/06; C08J 9/0071

(57) ABSTRACT

Provided is a foam sheet including a composition including polylactic acid. The polylactic acid includes, as monomer units, D-lactic acid and L-lactic acid, and an amount of the D-lactic acid or the L-lactic acid in the polylactic acid is 90 mol % or greater but less than 98 mol %. An amount of the polylactic acid is 97% by mass or greater relative to a total amount of organic matter in the foam sheet. When the foam sheet is cut into a square test piece, and the test piece is heated and stored for 90 minutes in a hot air circulation dryer a temperature of which is maintained at 90° C.±2° C., a change rate of an area of the test piece before and after the heat storage is within ±15%. An average thickness of the foam sheet is 0.5 mm or greater.

### CROSS-REFERENCE TO RELATED APPLICATIONS

The present application claims priority under 35 U.S.C. § 119 to Japanese Patent Application No. 2020-194334 filed Nov. 24, 2020. The contents of which are incorporated herein by reference in their entirety.

### BACKGROUND OF THE INVENTION

### Field of the Invention

The present disclosure relates to a foam sheet, a product, and a method for producing the foam sheet.

### Description of the Related Art

Plastic products are processed into and widely used as various shapes, such as bags, trays, and containers. However, the majority of the plastic products have properties that are not easily decomposed in the natural world, and therefore disposal thereof after use causes a problem. Therefore, developments of materials for replacing non-biodegradable plastics of the plastic products, which are not easily decomposed in the natural world, with biodegradable plastics that are decomposed in the natural world have been actively carried out.

Among plastics having biodegradability, polylactic acid has noted as a substitute for non-biodegradable plastics because the polylactic acid has the physical properties similar to the physical properties of polystyrene that has been used as plastics in the art, as well as having biodegradability.

Proposed is a polylactic acid composition foam sheet, which is a sheet having excellent mold processability, and is obtained by foaming the polylactic acid to reduce an amount of the polylactic acid to thereby use the polylactic acid over a wide area. When the polylactic acid is heated to be softened and melted, however, the polylactic acid is immediately turned into a fluid of low viscosity. Since the polylactic acid has a narrow range of the melt viscosity suitable for foaming, the polylactic acid has been known as a resin that is difficult to foam.

In order to obtain melt viscosity and tension suitable for foaming and shaping, addition of an acrylic resin having a high molecular weight (see Japanese Unexamined Patent Application Publication No. 2015-093952), or use of modified-polylactic acid obtained by copolymerizing lactic acid with another polyester structure obtained through dehydration condensation of succinic acid and ethylene glycol (see Japanese Unexamined Patent Application Publication No. 08-198992) has been attempted.

When application of a foam sheet for a heat resistant container is considered, moreover, it is desirable that the foam sheet does not cause the shape change at high temperatures, and the size of the foam sheet does not change. There is an example where a mechanical strength is maintained with a sheet substantially formed of polylactic acid alone, if the sheet has a sufficient thickness, and the sheet is applied for a thermal insulation material (see Japanese Patent No. 4299490).

### SUMMARY OF THE INVENTION

According to an aspect of the present disclosure, a foam sheet includes a composition including polylactic acid. The polylactic acid includes, as monomer units, D-lactic acid and L-lactic acid, and an amount of the D-lactic acid or the L-lactic acid in the polylactic acid is 90 mol % or greater but less than 98 mol %, An amount of the polylactic acid is 97% by mass or greater relative to a total amount of organic matter in the foam sheet. When the foam sheet is cut into a square test piece, and the square test piece is heated and stored for 90 minutes in a hot air circulation dryer a temperature of which is maintained at 90° C.±2° C., a rate of change in an area of the square test piece before and after the heat storage is within ±15%. An average thickness of the foam sheet is 0.5 mm or greater.

### BRIEF DESCRIPTION OF THE DRAWINGS

FIG. 1 is a schematic view illustrating one example of a shape of a sample when an area change rate is determined;

FIG. 2 is a schematic view illustrating one example of a shape of a sample when the number of cells is determined;

FIG. 3 is a schematic view illustrating one example of a shape of a sample when an open-cell ratio is determined;

FIG. 4 is a phase diagram illustrating a state of a material relative to a temperature and pressure;

FIG. 5 is a phase diagram for defining a range of a compressive fluid;

FIG. 6 is a schematic view illustrating one example of a kneading device; and

FIG. 7 is a schematic view illustrating one example of a foam sheet forming device.

### DESCRIPTION OF THE EMBODIMENTS

The foam sheet, the product, and the method for producing a foaming sheet according to the present disclosure will be described with reference to drawings hereinafter. The present disclosure is not limited to the embodiments described below. The embodiments may be changed within the range a person skilled in the art can arrive at, such as application of other embodiments, addition to the embodiments, modification of the embodiment, deletion from the embodiments, etc. Any of these embodiments are included in the scope of the present disclosure as long as the functions and effects of the present disclosure are obtained.

The foam sheet of the present disclosure is a foam sheet that includes a composition including polylactic acid. The polylactic acid includes, monomer units, D-lactic acid and L-lactic acid, and an amount of the D-lactic acid or the L-lactic acid in the polylactic acid is 90 mol % or greater but less than 98 mol %. An amount of the polylactic acid is 97% by mass or greater relative to a total amount of organic matter in the foam sheet. When the foam sheet is cut into a square test piece, and the square test piece is heated and stored for 90 minutes in a hot air circulation dryer a temperature of which is maintained at 90° C.±2° C., a rate of change in an area (may be referred to as an “area change rate” hereinafter) of the square test piece before and after the heat storage is within ±16%. An average thickness of the foam sheet is 0.5 mm or greater.

The present disclosure has an object to provide a foam sheet having desirable biodegradability, and excellent external appearance at high temperatures.

The present disclosure can provide a foam sheet having desirable biodegradability, and excellent external appearance at high temperatures.

Since the foam sheet of the present disclosure includes a composition including polylactic acid, the foam sheet of the present disclosure may be also referred to as a polylactic acid foam sheet, or a polylactic acid composition foam sheet. Although the details of the foam sheet dill be described :later, the foam sheet of the present disclosure has excellent heat resistance, and can be used, for example, for a heat resistant food container. The polylactic acid composition foam sheet is a sheet obtained by foaming a composition including polylactic acid and forming the composition into a sheet.

### (Foam Sheet)

The foam sheet of the present disclosure includes a composition including polylactic acid (may be also referred to as a polylactic acid-based resin or a polylactic acid resin). The composition includes polylactic acid, and may further include filler. The composition may denote a composition that is in the state before being foamed. Since the composition includes polylactic acid, the composition may be referred to as a polylactic acid composition. The composition may further include other components, such as a cross-linking agent according to the necessity.

The proposals in Japanese Unexamined Patent Application Publication Nos. 2015-093952 and 08-198992 have a problem that biodegradability owing to polylactic acid is impaired.

According to the proposal in Japanese Patent No. 4299490, it is difficult to achieve both heat resistance and biodegradability with a thin sheet having excellent moldability and resources saving.

The present inventors have diligently conducted researches in order to solve the above-described problems and obtain a foam sheet having both high temperature resistance and biodegradability. As a result, the present inventors have found that a high foaming expansion ratio and a closed cell structure can achieve thermal insulation, and a foam sheet having uniformly fine cells is obtained. Based on the insight as mentioned, the present disclosure has been accomplished.

### <Polylactic Acid>

Since a polylactic acid resin is biodegradable by microorganism, the polylactic acid resin has attracted attentions as an environmentally friendly polymer material that gives low environmental load (see “Structure and physical properties of aliphatic polyester, Biodegradable Polymer 2001, Vol. 50, No. 6, pp. 374-377”).

Examples of the polylactic acid include a copolymer of D-lactic acid and L-lactic acid, a homopolymer of D-lactide (D-lactic acid) or L-lactide (L-lactic acid), and a ring-opening polymer of one or two or more lactides selected from D-lactide (D-lactic acid)), L-lactide (L-lactic acid), and DL-lactide. The above-listed examples may be used alone or in combination. Moreover, the polylactic acid may be appropriately synthesized for use, or may be selected from commercial products.

In the present disclosure, as the polylactic acid, polylactic acid including D-lactic acid or L-lactic acid as monomer units, in which an amount of the D-lactic acid or the L-lactic acid in the polylactic acid is 90 mol % or greater but less than 98 mol %, is used. Although it is not intended to limit the definition, the polylactic acid including the lactic acid in an amount of 98 mol % or greater may be referred to as polylactic acid of a high optical purity region, and the polylactic acid including the lactic acid in an amount of less than 98 mol % may be referred to as polylactic acid of a low optical purity region compared to the polylactic acid including the lactic acid in the amount of 98 mol % or greater. Used in the present disclosure is the polylactic acid of the low optical purity region, where the amount of the D-lactic acid or L-lactic acid as the monomer unit in o the polylactic acid is within the above-mentioned range.

A copolymer of D-lactic acid and L-lactic acid tends to increase crystallinity thereof and increase a melting point or glass transition temperature thereof as the amount of the minor optical isomer decreases. The minor optical isomer is the optical isomer an amount of which is smaller than an amount of the other optical isomer. As the amount of the minor optical isomer increases, moreover, the copolymer tends to decrease crystallinity thereof; and eventually turns amorphous.

In the present disclosure, polylactic acid of a low optical purity region, which has low heat resistance, is used. As a result, a shape of a resultant foam sheet can be maintained at a high temperature because of thermal insulation owing to a high expansion ratio and closed cell structure, uniformity of the structure owing to uniform fine cells, and shape retention at a high temperature owing to robustness of the skeleton.

External appearance of a foam sheet including polylactic acid cannot be maintained at a high temperature, when an amount of the D-lactic acid or L-lactic acid as a monomer unit, in the polylactic acid is less than 90 mol %. The amount of the D-lactic acid or L-lactic acid as a monomer unit in the polylactic acid is preferably 94 mol % or greater but 98 mol % or less. A foam sheet using such polylactic acid is easily applied in the field of the food industry. Considering application of the foam sheet in the field of the food industry, the polylactic acid including L-lactic acid, which is lactic acid constituting the polylactic acid, in the amount of 94 mol % or greater is preferable, in case of the polylactic acid including L-lactic acid, which is lactic acid constituting the polylactic acid, in the amount of 94 mol % or greater, decomposition of the polymer is suppressed at a temperature of 40° C. or higher, and an elution amount of lactide can be kept low.

Whether the amount of the D-lactic acid or L-lactic acid as a monomer unit in the polylactic acid is 90 mol % or greater but less than 98 mol % in the polylactic acid of the foam sheet can be confirmed by liquid chromatography using an optically active column.

The measurement is performed as follows.

The foam sheet is frozen and pulverized to prepare a powder of the foam sheet. The foam sheet powder is collected in an Erlenmeyer flask by 200 mg, and 30 mL of a 1N sodium hydroxide aqueous solution is added to the powder. Next, the resultant mixture is heated to 65° C. with shaking the Erlenmeyer flask to dissolve the polylactic acid completely. Subsequently, the pH of the resultant solution is adjusted to from 4 through 7 with 1N hydrochloric acid, followed by diluting to the predetermined volume using a volumetric flask, to thereby obtain a polylactic acid solution.

Next, the polylactic acid solution is filtered with a membrane filter of 0.45 μm, followed by analyzing through liquid chromatography. Based on the Obtained chart, an area ratio is calculated from peaks derived from D-lactic acid and L-lactic acid. The area ratio is used as the abundance ratio to calculate an amount of the D-lactic acid and an amount of the L-lactic acid. The above-described operation is performed 3 times. The arithmetic means of the obtained values are calculated and determined as the amounts of the D-lactic acid and the L-lactic acid that are monomer units of the polylactic acid included the foam sheet.

The measuring device and measuring conditions are as follows. HPLC device (liquid chromatography): product name “PU-2085 Plus System”, available from JASCO Corporation
Column: produnamect “SUMICHIRALOA5000” (4.6 mm (diameter)×250 mm), available from Sumika Chemical Analysis Service, Ltd.
Column temperature: 25° C.
Mobile phase: a mixed liquid of a 2 mM CuSO₄ aqueous solution and 2-propanol (CuSO₄ aqueous solution:2-propanol (volume ratio)=95:5)
Mobile phase flow rate: 1.0 mL/min
Detector: UV 254 nm
Injection amount: 20 μL

The above-described measurement is performed on the foam sheet. When the larger area between the peak area of the peak derived from the D-lactic acid and the peak area of the peak derived from the L-lactic acid is 90% or greater but less than 98% relative to a total area of the peaks derived from D-lactic acid and the L-lactic acid, it can be determined that the amount of the D-lactic acid or L-lactic acid of the lactic acids constituting the polylactic acid is 90 mol % or greater but less than 98 mol %.

Considering biodegradability and recycling performance (i.e. easiness of recycling), an amount of the polylactic acid relative to a total amount of organic matter in the foam sheet is 97% by mass or greater, preferably 98% by mass or greater, and more preferably 99% by mass or greater. When the amount of the polylactic acid relative to the total amount of the organic matter in the foam sheet is less than 97% by mass, desirable biodegradability may not, be obtained. When the amount of the polylactic acid relative to the total amount of the organic matter in the foam sheet is 98% by mass or greater, a problem, such as components that are not biodegradable being remained after biodegrading the polylactic acid, can be prevented.

The majority of the organic matter in the foam sheet is the polylactic acid, and examples of the organic matter other than the polylactic acid include an organic nucleating agent (may be also referred to as organic filler), and a cross-linking agent. When an inorganic nucleating agent (may be also referred to as inorganic filler) is used as filler, the inorganic nucleating agent is not classified as the organic matter.

### —Measuring Method of Amount of Polylactic Acid—

The amount (proportion) of the polylactic acid can be calculated from the proportions of the raw materials. If the blending ratio of the raw materials is unknown, for example, the following GCMS is performed, and the result is compared to the standard sample using the known polylactic acid to thereby determine components. Optionally, the calculation can be performed in combination with a spectrum area ratio determined by NMR, or other analysis methods.

### [Measurement by GCMS]

GCMS: QP2010, available from Shin adzu Corporation, (accessory) Py3030D, available from Frontier Laboratories Ltd.
Separation column: Ultra ALLOY UAS-30M-0.25F, available from Frontier Laboratories Ltd.
Sample heating temperature: 300° C.
Column oven temperature: 50° C. (retained for 1 minute), heated at 15° C./min, 320° C. (retained for 6 minutes)
Ionization method: electron ionization (E.I.) method
Detection mass range: from 25 through 700 (m/z)

An amount of the organic filler can be also determined by GCMS in the similar manner.

### <<Total Amount of Organic Matter and Amount of Inorganic Filler>>

A total amount of the organic matter in the foam sheet can be estimated as an amount of the foam sheet excluding the mineral content(=an amount of inorganic components). Moreover, the mineral content can be regarded as an amount of the inorganic filler. The mineral content is determined as the residues when the foam sheet is burned at 600° C. for 4 hours.

The mineral content is measured in the following manner. A weight of a 100 mL crucible is weighed by a precision balance up to the fourth place after the decimal point. The foam sheet sample is collected in the crucible by about 3 g, and a total weight of the crucible and the sample is measured. The crucible is placed in Muffle Furnace FP-310, available from Yamato Scientific Co., Ltd., to burn at 600° C. for 4 hours to burn the organic components. Thereafter, the crucible is cooled for 1 hour in a desiccator, and the weight of the crucible is weighed again to measure the total weight of the crucible and the mineral content.

The mineral content, i.e., the amount of inorganic filler, and the total amount of organic matter are calculated according to the following equations.

Inorganic filler amount [%]=mineral content [%]=(a total weight [g] of crucible and sample after burning and cooling−a weight [g] of crucible)/(a total weight [g] of crucible and sample before burning a weight [g] of crucible)×100

A total amount of organic matter [%]=100−mineral content [%]

The above-described measurement is performed with n=2, and the average value is determined.

### <Filler>

The filler (may be also referred to as a “foam nucleating agent”) is added to adjust a size, amount, etc. of cells of the foam sheet.

Examples of the filler include an inorganic nucleating agent, and an organic nucleating agent. The above-listed examples may be used alone or in combination,

Examples of the inorganic nucleating agent include talc, kaolin, calcium carbonate, sheet silicate, zinc carbonate, wollastonite, silica, alumina, magnesium oxide, titanium oxide, calcium silicate, sodium aluminate, calcium aluminate, sodium aluminosilicate, magnesium silicate, glass balloons, carbon black, zinc oxide, antimony trioxide, zeolite, hydrotalcite, metal fiber, metal whiskers, ceramic whiskers, potassium titanate, boron nitride, graphite, glass fiber, and carbon fiber.

Examples of the organic nucleating agent include polymers found in nature, such as starch, cellulose particles, wood meal, soy pulp, rice husk, and bran, and modified products thereof, sorbitol compounds, benzoic acid and metal salts thereof phosphoric acid ester metal salts, and rosin compounds.

Among the above-listed examples, inorganic nucleating agents are preferable considering influence to the environment. Among the inorganic nucleating agents, silica, titanium oxide, and sheet silicate are more preferable because dispersion of nano-scale is achieved to form uniform cells.

An amount of the filler in the foam sheet is preferably 3% by mass or less. When the amount of the filler is greater than 3% by mass, the physical properties of the polylactic acid composition foam sheet may be hard and brittle. The amount of the filler that is not biodegradable is preferably as small as possible, and the amount thereof in the foam sheet is preferably 1% by mass or less.

The number average particle diameter of the filler is preferably 4 nm or greater but 100 nm or less. When the number average particle diameter of the filler is 4 nm or greater, advantages that the particles are not easily increase the size due to re-aggregation, and the nucleating agent is sufficiently dispersed are obtained. When the number average particle diameter of the filler is 100 nm or less, a sufficiently large interface with the resin can be obtained with the amount of the filler similar to the amount of the larger particles, and therefore the composition is effectively foamed. The number average particle diameter of the filler can be determined, for example, by a transmission electron microscope (TEM), or a scanning electron microscope (SEM).

### <Other Components>

Other components are not particularly limited as long as the components are components typically contained in a foam sheet, and may be appropriately selected depending on the intended purpose. Examples thereof include a cross-linking agent.

### <<Cross-Linking Agent>>

The cross-linking agent is not particularly limited as long as the cross-linking agent is a compound that is reactive with a hydroxyl group and/or carboxylic acid group of the polylactic acid. For example, an epoxy-based cross-linking agent (a cross-linking agent including an epoxy group) or an isocyanate-based cross-linking agent (a cross-linking agent including an isocyanate group) is preferably used. As the cross-linking agent, for example, an epoxy functional (meth)acryl-styrene-based cross-linking agent including 2 or more epoxy groups per molecule, or polyisocyanate including 2 or more isocyanate groups per molecule is preferable. An epoxy functional (meth)acryl-styrene-based cross-linking agent including 3 or more epoxy groups per molecule, or polyisocyanate including 3 or more isocyanate groups per molecule is more preferable because a branch structure can be introduced into polylactic acid, melt strength is effectively improved, and unreacted residues can be reduced. Use of the above-listed cross-linking agent can suppress coalescence of cells and foam breaking, and prove an expansion ratio.

The epoxy functional (meth)acryl-styrene-based cross-linking agent having 2 or 3 or more epoxy groups per molecule is a polymer obtained by copolymerizing a (meth)acryl monomer including an epoxy group and a styrene monomer.

Examples of the (meth)acryl monomer including an epoxy group include monomers including a 1,2-epoxy group, such as glycidyl acrylate, glycidyl methacrylate. Moreover, examples of the styrene monomer include styrene, and α-methyl styrene.

The epoxy functional (meth)acryl-styrene-based cross-linking agent including 2 or more epoxy groups per molecule may include, as a copolymer component, a (meth)acryl monomer that does not include an epoxy group. Examples of the (meth)acryl monomer include methyl acrylate, ethyl acrylate, propyl acrylate, butyl acrylate, cyclohexyl acrylate, methyl methacrylate, ethyl methacrylate, propyl methacrylate, butyl methacrylate, and cyclohexyl methacrylate.

Examples of the polyisocyanate including 2 or more isocyanate groups per molecule include: aliphatic diisocyanate, such as 1,6-hexamethylene diisocyanate, 3-isocyanatemethyl-3,5,5-trimethylcyclohexylisocyanate (isophorone diisocyanate), 1,4-tetramethylene diisocyanate, 2,4,4-trimethylhexamethylene diisocyanate, 2,2,4-trimethylhexamethylene diisocyanate, dicyclohexylmethane-4,4′-diisocyanate, methylcyclohexyl-2,4-diisocyanate, methylcyclohexyl-2,6-diisocyanate, xylylene diisocyanate, 1,3-bis(isocyanate)methylcyclohexane, tetramethylxylylene diisocyanate, trans-cyclohexane-1,4-diisocyanate, and lysine diisocyanate; alicyclic polyisocyanate, such as isophorone diisocyanate, hydrogenated diphenylmethane diisocyanate, hydrogenated tolylene diisocyanate, hydrogenated xylylene diisocyanate; hydrogenated tetramethylxylylene dilsocyanate, and cyclohexane diisocyanate; aromatic diisocyanate, such as 2,4-toluylenediisocyanate, 2,6-toluylenediisocyanate, diphenylmethane-4,4′-isocyanate, 1,5′-naphthenediisocyanate, tricine diisocyanate, diphenylmethylmethane diisocyanate, tetraalkyldiphenylmethane diisocyanate, 4,4′-dibenzyldiisocyanate, and 1,3-phenylene diisocyanate; triisocyanate compounds, such as lysine ester triisocyanate, triphenylmethane triisocyanate, 1,6,11-undecanetriisocyanate, 1,8-isocyanate-4,4-isocyanatemethyloctane, 1,3,6-hexamethylene triisocyanate, bicycloheptane triisocyanate, adducts of trimethyloipropane and 2,4-tolutylenediisocyanate, and adducts obtained by reacting trimethylolpropane with diisocyanate, such as 1,6-hexamethylene diisocyanate; and modified polyisocyanate compounds obtained by reacting polyvalent alcohol (e.g., glycerin, and pentaerythritol) with the aliphatic diisocyanate compound, the aromatic diisocyanate compound, or the triisocyanate compound. The above-listed examples may be used alone or in combination.

An amount of the cross-linking agent added varies depending on a molecular weight or molecular weight distribution of polylactic acid for use. When the amount of the polylactic acid having a low molecular weight is large, a large amount of the cross-linking agent needs to be added in order to impart melt strength suitable for foaming. However, biodegradability tends to be lowered as the amount of the cross-linking agent increases. Therefore, the amount of the cross-linking agent in the polylactic acid composition foam sheet of the present disclosure is preferably 2 parts by mass or less, relative to 100 parts by mass of a total amount of the mixture of the polylactic acid and the cross-linking agent.

As other cross-linking agents, a compound having 2 or more oxazoline groups per molecule, a compound having 2 or more carbodiimide groups (polycarbodiimide-based cross-linking agent), etc., may be used.

Since the composition includes the cross-linking agent, melt tension can be imparted, and an expansion ratio of the polylactic acid composition foam sheet can be adjusted. Examples of other methods for imparting melt tension include: a method where filler, such as sheet silicate, is dispersed in nano-scale; a method where a resin composition is crosslinked using a cross-linking agent or a crosslinking aid etc.; a method where a resin composition is crosslinked by electron beams, etc.; and a method where another resin composition having high melt tension is added.

### <<Others>>

Examples of the above-mentioned other components include, in addition to the above-mentioned components, additives, such as a heat stabilizer, an antioxidant, and a plasticizer. The above-listed examples may be used alone or in combination.

Considering biodegradability and recycling performance, an amount of the above-mentioned other components is preferably 2% by mass or less, and more preferably 1% by mass or less, relative to a total amount of the organic matter in the foam sheet.

### <Physical Properties of Foam Sheet>

### <<Area Change Rate Before and After Heat Storage>>

In the present disclosure, when a square test piece cut out from the foam sheet is heated and stored for 90 minutes in a hot air circulation dryer maintained at 90° C.±2° C., and a rate of change in the area of the square test piece before and after the heat storage (may be referred to as an “area change rate before and after heat storage” or “area change rate during heating”) is within ±15%, When the area change rate of the test piece is within ±15%, the size stability at high temperatures is excellent, and the foam sheet can be used, for example, for a heat resistant container of a simple structure.

Examples of a method for adjusting the area change rate before and after heat storage to the above-mentioned range include: a method where an expansion ratio is adjusted to 10 times or greater to enhance thermal insulation; a method where a closed cell structure is formed to have an open-cell ratio of 20% or less to thereby enhance thermal insulation; and a method where filler having the number average particle diameter of from 4 nm through 100 nm is used to uniformly and finely form to make the structure uniform and robust.

The area change rate before and after heat storage is preferably ±10% or less, and more preferably 5% or less. When the area change rate before and after heat storage is within ±10%, the foam sheet can be used for a container of a large size. When the area change rate before and after heat storage is ±5% or less, the foam sheet can be used for heat resistant purpose, such as a product having a complicated shape.

In the present embodiment, the area change rate before and after heat storage is determined in the following manner.

The foam sheet left to stand for 24 hours or longer in the environment having a temperature of 23° C. and relative humidity of 50% is cut into a square having a length of 15 cm and a width of 15 cm with a surface perpendicular to the thickness direction, to thereby prepare a sample. If the rectangular having a length of 15 cm, and a width of 15 cm cannot be cut out, the maximum square is cut out from the foam sheet as a sample. The sample is stored for 90 minutes in the environment a temperature of which is controlled at 90° C.±2° C. by means of a hot air circulation dryer (e.g., DN-400, available from Yamato Scientific Co., Ltd.). Thereafter, the sample is left to stand for 1 hour in the environment having a temperature of 23° C., and relative humidity of 50%, and the area is determined. The area change rate is then calculated according to the following equation.

Area change rate={(area before heat storage−area after heat storage)/area before heat storage}×100

The area change rate before and after the heat storage is determined, for example, by measuring 3 samples, and calculating an average value.

When a value of the area change rate before and after heat storage is positive in the formula above, it means the foam sheet is expanded after the heat storage. When a value of the area change rate before and after heat storage is negative, it means the foam sheet is shrank after heat storage. A reason why a different change is observed after heating is probably because of a state of strain the molecules received during the production, or additional foaming due to residues of the foaming agent. When a sheet is drawn during the production, for example, the molecules are strongly stretched and fixed in the machine direction (MD). Once the molecules become mobile as heated, the sheet may shrink in the MD, and expand in the transverse direction (TD). When the expansion ratio is high and the foam sheet is largely expanded in all direction without any drawing operation, moreover, the molecules are fixed in the state where the molecules are forced to be stretched. Once the molecules become mobile, therefore, the sheet may shrink in all directions. When the chemical foaming agent is remained as residues, moreover, the sheet becomes foamable again as heated, and therefore the sheet may expand in all directions.

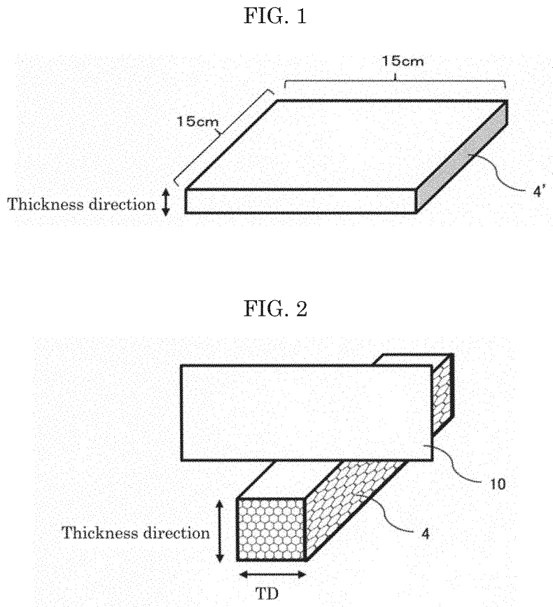

The sample is additionally described with reference to FIG. 1. As described above, the foam sheet is cut to obtain a square having a length of 15 cm and a width of 15 cm on a surface thereof perpendicular to the thickness direction thereof. The resultant cut piece is used as a sample 4′.

### <<Average Thickness>>

The average thickness of the foam sheet of the present disclosure is 0.5 mm or greater. When the average thickness of the foam sheet is less than 0.5 nm, the shape of the foam sheet may be waved or curled after storage at a high temperature, and desirable shape or size stability at high temperatures may not be obtained. In the present disclosure, a foam sheet, which has been foamed finely and uniformly can be obtained. In this case, the shape or size stability can be secured at high temperatures when the average thickness of the foam sheet is adjusted to the above-mentioned range.

The average thickness of the foam sheet is not particularly limited, but the average thickness thereof is preferably 10 mm or less. When the average thickness of the foam sheet is 10 mm or less, mold processability into a container etc. can be improved, and consumption of materials can be kept minimum,

The average thickness of the foam sheet is more preferably 0.5 mm or greater but 5 mm or less. When the average thickness of the foam sheet is 5 mm or less, the foam sheet is more desirably suitable for processing into a food container or tray.

The average thickness of the foam sheet is determined by measuring a thickness at 10 points by means of a caliper (e.g., DigiMax Caliper, available from Mitutoyo Corporation), and calculating an average value of the measured values.

### <<Bulk Density>>

The bulk density of the foam sheet is preferably 0.025 g/cm³ or greater but 0.125 g/cm³ or less. When the bulk density of the foam sheet is 0.025 g/cm³ or greater, the strength of the foam sheet that may be applied for a container can be improved. When the bulk density thereof is 0.125 g/cm³ or less, a problem, such as waving of the sheet during high-temperature storage, may be prevented. Considering the better stability of the shape of the foam sheet at high temperatures, the bulk density of the foam sheet is more preferably 0.0625 g/cm³ or less.

### <<The Number of Cells>>

As a method for estimating the foaming state of the foam sheet, the foaming state can be estimated by counting the number of cells per 1 mm². The number of cells per 1 mm² is preferably 50 or greater. The larger number thereof is more preferable. When the number of cells per 1 mm² is 50 or greater, a thickness of a cell wall is prevented from being too thick, to thereby secure desirable prevent thermal insulation. Moreover, unevenness of the skeleton can be prevented, and therefore the form and size are easily maintained after storage at a high temperature. The number of cells can be determined, for example, by means of a scanning electron microscope (SEM).

The method for measuring the number of cells per 1 mm² will be described with reference to FIG. 2.

The foam sheet 4 is cut by a sharp razor blade 10 (76 Razor, available from Nissin EM Co., Ltd.) so that the thickness direction of the foam sheet is to be a vertical direction, and the TD is to be a horizontal direction. The obtained cross-section of the foam sheet is observed by SEM VE-9800, available from KEY ENCS CORPORATION. The obtained cross-section SEM photographs (magnification: 50 times) are binarized into the gray component corresponding to a cell and the resin component (white) using image analysis software (Image-Pro Premier, available from Mediacy), and the number of cells is counted with the Count/Size command. Thereafter, the obtained value is converted into the number of cells in the range of 1 mm×1 mm. In order to evaluate the sheet evenly without variability, the sample is cut in 2 locations separated from each other to expose cross-sections, the number of cells within the range of 1 mm×1 mm is calculated, and then the average of the values obtained from 3 locations is determined to calculate the average number of cells per 1 mm². When the range of 1 mm×1 mm cannot be secured within the foam sheet, the maximum square is cut out, the number of cells therein is counted, and then the resultant value is converted into the number of cells per 1 mm×1 mm.

Observation of cross-sections of the thickness direction and the TD, which are not affected by the winding speed, is preferable. When the MD cannot be determined because of vertical lines seen on the external appearance of the sheet, in case of the sheet in the form of a roll the longitudinal direction is assumed as the MD, and a square is cut out along the direction perpendicular to the Mi) and the thickness direction. When the foam sheet is a small board or molded product and the MD cannot be determined from the external appearance, it is assumed that there is no anisotropy between the MD and the TD, and the thickness direction is taken as a longitudinal direction, and an arbitral direction may be taken as a width direction.

Examples of a method for adjusting the number of cells per 1 mm² to the above-mentioned range include: a method where an amount of filler is adjusted; a method where a master batch is used; and a method where a particle diameter of filler is adjusted. The number of cells per 1 mm² can be increased by forming fine foam, which can be achieved by increasing an amount, of filler, using a master batch including filler to improve dispersibility of the filler, or reducing a particle size of filler to increase an area of the interface with the resin.

### <<Open-Cell Ratio>>

The open-cell ratio is a proportion of a volume of cells exposed to the external atmosphere in a bulk of the sample (including pores on the surface and voids inside the sample). It is preferred that the foam sheet of the present disclosure maintain thermal insulation with the low open-cell ratio thereof. The open-cell ratio can be measured by means of an air pycnometer. The open-cell ratio of the foam sheet is preferably 20% or lower. When the open-cell ratio of the foam sheet is 20% or less, thermal insulation is not impaired, and the form or size of the foam sheet does not change at high temperatures.

For example, the open-cell ratio of the foam sheet is determined according to ASTM D-2856.

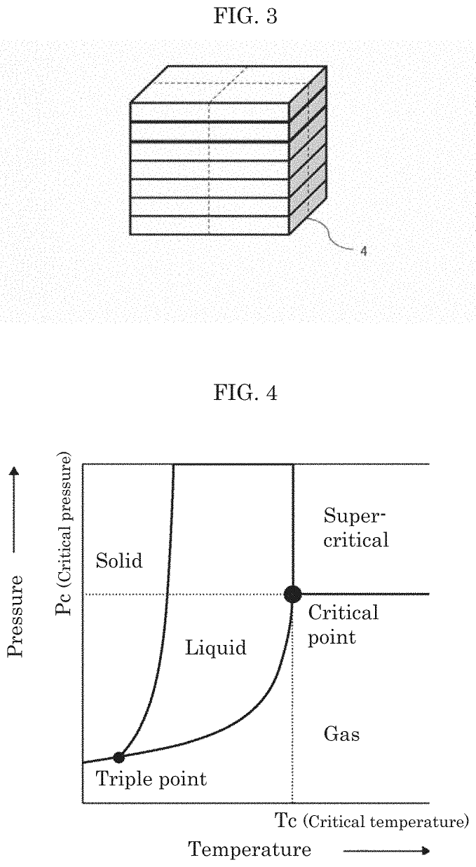

A measurement example thereof will be described with reference to FIG. 3. The several number of the foam sheets to achieve a total thickness of about 30 mm are prepared. A thickness thereof is measured by means of a caliper (e.g., DigiMax Caliper, available from Mitutoyo Corporation). The foam sheets are cut into squares having the sides having the same length as the above-mentioned thickness by a sharp razor blade (76 Razor, available from Nissin EM Co., Ltd.) to obtain a cube formed of the stacked foam sheets, where the cube has a side of about 30 mm. A geometric volume of the cube (Vg, the volume including open cells on the cross-sections) is calculated from the size thereof. The sample is measured by a dry automatic pycnometer AccuPyc II 1340, available from Shimadzu Corporation, to determine the sample volume excluding the open cells (Vp1). The cube is cut twice by a sharp knife along the direction vertical to the thickness of the cube, parallel to the side surface, and passing through the centers of the top and bottom surfaces (broken lines in FIG. 3). The number of cells exposed by the cutting is, for example, (the original 4 side surfaces+newly cut 4 surfaces)/the original 4 side surface=2 times. The sample after curing is measured again by AccuPyc II 1340, to thereby determine a sample volume (Vp2).

Vp1 and Vp2 are represented by Formula (1) and Formula (2), where Voc is the volume of the original open cells, and Vcc is the volume of the cells open in the process of the preparation of the sample (originally the closed cells).

Vp1=Vg−Voc−Vcc Formula (1)

Vp2=Vg−Voc−2Vcc Formula (2)

If Vcc is deleted from Formulae (1) and (2) to expand the formulae, it is represented by Formula (3).

Voc=Vg−2Vp1+Vp2 Formula (3)

As a result, the open-cell ratio can be represented by the following formula, and the open-cell ratio can be determined.

Open-cell ratio=Voc/Vg×100=(Vg−2Vp1+Vp2)/Vg×100

A method for adjusting the open-cell ratio of the foam sheet to the above-mentioned range may be appropriately selected. Examples of the method for suppressing the number of open cells include a method where strain hardening properties are imparted to the resin to suppress foam breaking. For example, usable is a method where the cross-linking agent is added and is evenly reacted with the polylactic acid resin serving as a main component to the extent where gelation that may inhibit foaming does not occur.

### <<Volatile Component>>

In the present disclosure, the foam sheet is preferably substantially free from a volatile component. Since the foam sheet is substantially free from a volatile component, adverse effects on human bodies and environment can be reduced, as well as improving size stability. Examples of the volatile component that may be included include an organic solvent, and a foaming agent, such as butane.

In the present disclosure, for example, carbon dioxide (CO₂), which is used as a compressive fluid as described below, may also function as a foaming agent. When a compressive fluid of carbon dioxide or nitrogen is used as a compressive fluid and a foaming agent, the foaming agent is promptly dispersed into the atmosphere from the foam sheet just after the production, and therefore the produced foam sheet is in the state substantially free from a volatile component. In the present specification, the term “substantially” means equal to or lower than the detection limit in the following analysis.

Part of the foam sheet is prepared as a sample. To 1 part by mass of the sample, 2 parts by mass of 2-propanol is added. The resultant mixture is dispersed by ultrasonic waves for 30 minutes, followed by storing for 1 day in a refrigerator (5° C.) to obtain a volatile component extract. The volatile component extract is analyzed by gas chromatography (GC-14A, available from Shimadzu Corporation) to quantify the volatile component in the foam sheet. The measuring conditions are as follows.
Device: Shimadzu GC-14A
Column: CBP20-M 50-0.25
Detector: FID
Injection amount: from 1 μL through 5 μL
Carrier gas: He 2.5 kg/cm²
Hydrogen flow rate: 0.6 kg/cm²
Air flow rate: 0.5 kg/cm²
Chart speed: 5 mm/min
Sensitivity: Range 101×Atten 20
Column temperature: 40° C.
Injection Temp: 150° C.

Specifically, it is preferred that an organic compound having a boiling point of −20° C. or higher but lower than 150° C. at 1 atm be not detected when the following measurement is performed on the foam sheet of the present disclosure.

### [Measurement]

Part of the foam sheet is dispersed in a solvent, and the extract liquid of the volatile component is subjected to gas chromatography under the above-described conditions to thereby quantify the organic compound.

As described above, the foam sheet of the present embodiment can use a material other than an organic compound (e.g., CO₂) as the foaming agent. In order to design the foam sheet of the present disclosure from which the organic compound is not detected by the above-described measurement, for example, the volatile component content can be made substantially 0% by mass by using CO₂ as a foaming agent. Since the foam sheet is a foam sheet from which the organic compound is detected, the foam sheet does not generate odor.

### (Product)

The foam sheet of the present disclosure may be used as it is, or may be used as a product.

The product using the foam sheet of the present disclosure is not particularly limited and may be appropriately changed. The product of the present disclosure includes the foam sheet of the present disclosure and may further include other components according to the necessity. The above-mentioned other components are not particularly limited as long as the components are components typically used for resin products, and may be appropriately selected depending on the intended purpose.

The foam sheet of the present disclosure may be processed into the product of the present disclosure. The processing of the foam sheet is not particularly limited. For example, the foam sheet may be subjected to a process for processing the foam sheet using a mold to produce a product. The method for processing the sheet using the mold is not particularly limited, and may be selected from any of methods for thermoplastic resins known in the art. Examples thereof include vacuum molding, pressure forming, vacuum pressure forming, and press molding.

Examples of the product (may be also referred to as a “consumer product”) include household products, such as bags, packaging containers, trays, tableware, cutlery, and stationary, and buffer materials. The term “product” includes not only a whole material in the form of a sheet or roll to be processed into a product, and a product per se, but also a product including parts, such as handles of a tray, or a product such as a tray to which handles are attached.

Examples of the bag include plastic bags, shopping bags, and bin liners.

Examples of the stationary include clear files, and patches.

Conventional foam sheets have a problems in physical properties, such as strength and flexibility of sheets, because a diameter of cells of foam is large, and a variation in the size of cells is large.

The product obtained by molding the foam sheet of the present disclosure has excellent physical properties, thus the product can be widely applied for applications, such as industrial materials, sheets for agricultural products, food products, medical products, and cosmetic products, and wrapping materials.

The foam sheet of the present disclosure is effective for use utilizing biodegradability of the foam sheet, particularly as wrapping materials for food products, and medical sheets for cosmetic products or medical products. The improvement in performance thereof can be expected by reducing a thickness of the foam sheet etc.

### (Method for Producing Foam Sheet)

The method for producing a foam sheet of the present disclosure include a kneading step, and a foaming step. The method may further include other steps according to the necessity. The kneading step and the foaming step may be performed simultaneously, or may be performed separately.

### <Kneading Step>

The kneading step is a step including kneading polylactic acid and filler at a temperature lower than a melting point of the polylactic acid in the presence of a compressive fluid. Moreover, the amount of D-lactic acid or L-lactic acid of the lactic acids constituting the polylactic acid is preferably 90 mol % or greater but less than 98 mol % in the polylactic acid.

A cross-linking agent may be used in the kneading step. When the filler and the cross-linking agent are used in the kneading step, polylactic acid, filler and a cross-linking agent may be kneaded at once to obtain a composition, or polylactic acid and filler are kneaded to obtain a composition precursor, and a crosslinking agent is added to the composition precursor to prepare a composition.

The composition of the present embodiment includes the polylactic acid and the filler, and mast further include the cross-linking agent according to the necessity. The composition is in the state before being foamed. Since the composition includes the polylactic acid, the composition may be referred to as a polylactic acid composition. Moreover, the composition precursor may be referred to as a master batch. For example, the composition precursor processed to pelletize may be referred to as a master batch.

As the polylactic acid, filler, and cross-linking agent for use in the kneading step, the above-described polylactic acid, filler, and cross-linking agent may be used, and therefore descriptions thereof are omitted.

### <<Compressive Fluid>>

Aliphatic polyester, such as polylactic acid, has characteristics is that a melt viscosity thereof is sharply decreased at a melting point thereof or higher. When the aliphatic polyester is kneaded with filler etc., therefore, filler tends to aggregate. Moreover, the above-mentioned aggregate is significant when the size of filler particles is small.

In the present disclosure, the polylactic acid and the filler are kneaded in the presence of the compressive fluid. Since kneading is performed using the compressive fluid, the filler is easily dispersed in the polylactic acid evenly. A reason why it is preferable to use the compressive fluid for kneading the filler and the polylactic acid will be described hereinafter.

It has been known that a resin is generally plasticized by a compressive fluid to reduce a melt viscosity of the resin (see “The Latest Applied Technology of Supercritical Fluid” NTS Inc.). In a kneading step, however, the higher melt viscosity of the resin can impart the higher shearing force to the filler, and therefore the higher melt viscosity is preferable in view of dispersibility because aggregates are made fine.

Therefore, it, seems that the reduction of the melt viscosity of the resin as a result of permeation of the compressive fluid is contradicted with improvement in kneadability. In fact, there is a case where pressure is applied during kneading with typical filler without using a compressive fluid. However, the application of the pressure during kneading with the filler aims to reduce the free volume of the resin to increase interaction within the resin (increase in the viscosity), and the plasticization of the resin is the opposite effect (see “k. Yang. R. Ozisik R. Polymer, 47, 2849 (2006)”).

The present inventors have diligently researched on whether a compressive fluid is utilized for kneading polylactic acid and filler together or not. As a result, the present inventors have found that, the viscosity of polylactic acid can be adjusted in the presence of a compressive fluid to the viscosity suitable for kneading, as long as a temperature is a temperature lower than a melting point of the polylactic acid, and the filler can be uniformly dispersed therein. In the art, polylactic acid and filler can be kneaded only in the low melt viscosity range at a temperature equal to or higher the melting point of the polylactic acid. In the present disclosure, however, dispersibility of filler can be further improved because the polylactic acid and the filler can be kneaded in the highly viscous state at a temperature lower than the melting point of the polylactic acid using a compressive fluid.

Depending on a type of a compressive fluid for use, moreover, the compressive fluid can also function as a foaming agent. When a foam sheet is produced, a foaming agent is generally used. The present inventors however have found that a compressive fluid of carbon dioxide, nitrogen, etc. can be used as a foaming agent in production of a foam sheet formed of a polylactic acid composition. When the compressive fluid is used as the foaming agent, kneading and foaming can be performed in a series of processes. Therefore, such a production process is preferable considering reduction in the environmental load.

Examples of a substance that can be used in the state of a compressive fluid include carbon monoxide, carbon dioxide, dinitrogen monoxide, nitrogen, methane, ethane, propane, 2,3-dimethylbutane, ethylene, and dimethyl ether. Among the above-listed examples, carbon dioxide is preferable because the critical pressure is about 7.4 MPa and the critical temperature is about 31° C., and therefore a supercritical state of carbon dioxide is easily created. In addition, carbon dioxide is non-flammable, and thus it is easily handled. The compressive fluid may be used alone or two or more compressive fluids may be used in combination.

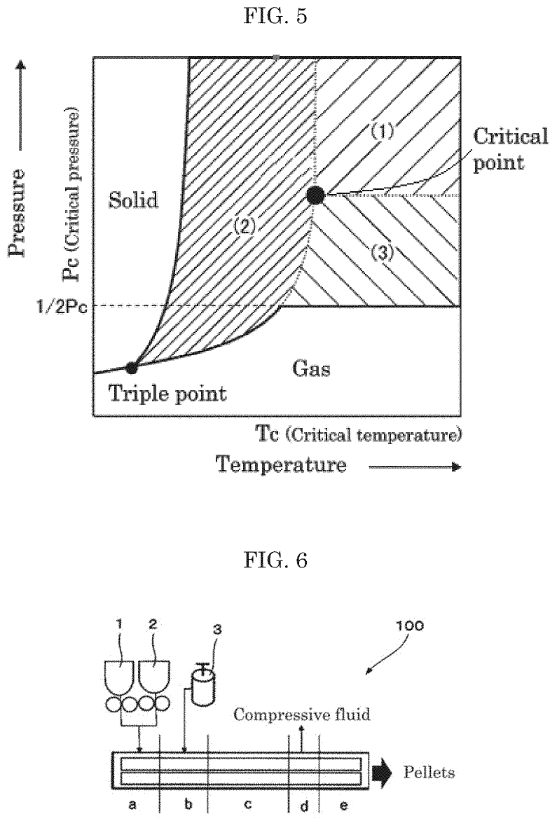

The compressive fluid used in the present disclosure will be described with reference to FIGS. 4 and 5. FIG. 4 is a phase diagram illustrating a state of a substance relative to a temperature and pressure. FIG. 5 is a phrase diagram for defining the range of the compressive fluid. In the present embodiment, the term “compressive fluid” means a state of a substance present in any of the regions (1), (2), or (3) of FIG. 5 in the phrase diagram of FIG. 4.

In such regions, the substance is known to have extremely high density and show different behaviors from those known at a room temperature and atmospheric pressure. The substance is in the state of a supercritical fluid, when the state thereof is in the region of (1). The supercritical fluid is a fluid that exists as a non-condensable high-density fluid at a temperature pressure exceeding the limiting point (critical point), at which a gas and a liquid can coexist. The supercritical fluid is a fluid that does not condense even when compressed. The substance is in the state of a liquid, when the state thereof is in the region of (2). The substance in the state of the liquid is a liquid gas obtained by compressive the substance in the state of the gas at a room temperature (25° C.) and atmospheric pressure (1 atm). The substance is the in the state of a gas, when the state thereof is in the region of (3). The substance in the state of the gas is a high-pressure gas the pressure of which is 1/2 of the critical pressure (Pc) or higher, i.e., 1/2 Pc or higher.

Since the solubility in the compressive fluid varies depending on the combination of a resin for use and the compressive fluid, a temperature, and pressure, a supply amount of the compressive fluid is appropriately adjusted. In case of the combination of polylactic acid and carbon dioxide, for example, a supply amount of the carbon dioxide is preferably 2% by mass or greater but 30% by mass or less, relative to 100% by mass of a composition (including polylactic acid and filler, optionally a cross-linking agent etc.). When the supply amount of the carbon dioxide is 2% by mass or greater, a problem that a plasticizing effect is limited can be prevented. When the supply amount of the carbon dioxide is 30% by mass or less, the following problem can be prevented. That is, separation between the carbon dioxide and the polylactic acid occurs and a foam sheet of a uniform thickness cannot be obtained.

In the present disclosure, a compressive fluid of carbon dioxide or nitrogen is preferably used. As described above, the obtained foam sheet is preferably substantially free from a volatile component, and is more preferably substantially free from an organic compound having a boiling point of −20° C. or higher but lower than 150° C. The phrase “substantially free from” means as described description of the volatile component associated with the physical properties of the foam sheet. Since a compressive fluid of carbon dioxide, nitrogen, etc. functions as a foaming agent, and another foaming agent is not used as a volatile component, a resultant foam sheet does not generate odor and can be handled safely.

### <<Other Foaming Agents>>

In addition to the compressive fluid, another foaming agent may be used. Considering easily forming a foam sheet of a high expansion ratio, examples of another foaming agent include: hydrocarbons, such as lower alkane (e.g., propane, normal-butane, isobutane, normal-pentane, isopentane, and hexane); ethers, such as dimethyl ether; halogenated hydrocarbons, such as methyl chloride, and ethyl chloride; and physical foaming agents, such as a compressive fluid of carbon dioxide or nitrogen. As described above, in the present disclosure, use of a compressive fluid of carbon dioxide or nitrogen as a foaming agent is preferable.

### <<Kneading Device>>

A kneading device for use in the production of the polylactic acid composition may be a device employing a continuous process or a batch process. The kneading device is preferably a device appropriately employing a reaction process, considering efficiency of the device, properties and quality of a product.

As the kneading device, a monoaxial extruder, a biaxial extruder, a kneader, a no-shaft basket stirring chamber, Bivolac available from Sumitomo Heavy Industries, Ltd., N-SCR available from Mitsubishi Heavy Industries, Ltd., a spectacle-shaped blade polymerization reactor available from Hitachi, Ltd., a lattice wing or Kenics-type, Sulzer-type, or SMLX-type static mixer-equipped tube polymerization reactor may be used because such devices can correspond to the viscosity suitable for kneading. Considering color tone, preferable examples thereof include a finisher, which is a self-cleaning polymerization device, N-SCR, and a biaxial extruder. Among the above-listed examples, a finisher and N-SCR are preferable considering production efficiency, color toner of the resin, stability, and heat resistance.

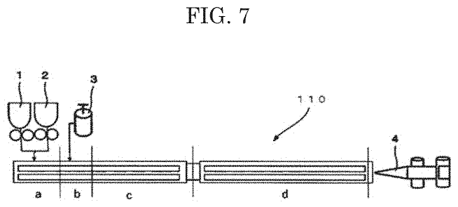

One example of the kneading device is illustrated in FIG. 6. As the illustrated continuous kneading device 100, for example, a biaxial extruder (available from The Japan Steel Works, LTD.) may be used. For example, a screw opening diameter is 42 mm, and L/D=48. In the present embodiment, for example, raw materials, such as polylactic acid, filler, etc., are supplied from the first supply section 1 and the second supply section 2 to the raw material mixing-melting area a, and the supplied raw materials are mixed and melted. To the mixed and melted raw materials, a compressive fluid is supplied from the compressive fluid supply sectional in the compressive fluid supply area b. Subsequently, the resultant mixture is kneaded in the kneading area c. Next, the compressive fluid is removed in the compressive fluid removing area d, followed by the result is formed into, for example, pellets in the molding area e. In the manner as described above, a master batch can be produced as a composition precursor.

For example, the compressive fluid (fluid material) is supplied by a metering pump, and solid raw materials, such as resin pellets and filler, are supplied by a quantitative feeder.

### —Raw Material Mixing-Melting Area—

In the raw material mixing-melting area, the resin pellets and the filler are mixed and heated. The heating temperature is set to a temperature equal to or higher than a melting point of the resin, so that the raw materials are in the state that can be homogeneously mixed with a compressive fluid in the sequential area where the compressive fluid is supplied.

### —Compressive Fluid Supplying Area—

In the state where the resin pellets are melted by heating to wet the filler, a compressive fluid is supplied to plasticize the melted resin.

### —Kneading Area—

A temperature of the kneading area is set to achieve an appropriate viscosity for kneading with filler. The set temperature is not particularly limited because the set temperature varies depending on the specification of a reaction device for use, a resin for use, a structure and molecular weight of the resin, etc. In case of commercially available polylactic acid having the weight average molecular weight (Mw) of about 200,000, the typical kneading is performed at a temperature that is higher than the inciting point of the polylactic acid by 10° C. to 20° C.

In the present disclosure, in contrast, kneading can be performed at a temperature lower than the melting point of the polylactic acid, and the kneading can be performed with relatively high viscosity at the temperature lower than the melting point of the polylactic acid. Specifically, the temperature is a temperature that is lower than the melting point of the polylactic acid by 20° C. through 80° C., more preferably by 30° C. through 60° C. The temperature may be simply set based on a current value of stirring power of the device, but the above-listed set value is the range, which is only achieved by the present disclosure, and cannot be generally achieved in the art.

### <<Foam Sheet Forming Device>>

Next, a foam sheet is produced by a foam sheet forming device. As the foam sheet device, a device listed as the kneading device above may be used. The kneading device and the foam sheet forming device may be one device, or may be separate devices.

One example of the foam sheet forming device will be illustrated in FIG. 7. Similarly to the above, for example, a biaxial extruder may be used as the continuous foam sheet forming device 110. In the continuous foam sheet forming device 110, for example, raw materials, such as a master batch, polylactic acid, a cross-linking agent, etc. are supplied from the first supply section 1 and the second supply section 2 to the raw material mixing-melting area a, and the raw materials are mixed. and melted. To the mixed and melted raw materials, a compressive fluid is supplied from the compressive fluid supply section 3 in the compressive fluid supply area b.

Subsequently, the resultant mixture is kneaded in the kneading area c, to thereby obtain a composition. Next, the composition is supplied to the heating area d, and is heated and kneaded in the heading area, followed by returning to the atmospheric pressure to extrude and foam the composition. The extruded and foamed foam sheet 4 is wound around a mandrel.

In the continuous foam sheet forming device 110, the raw material mixing-melting area a, the compressive fluid supplying area b, and the kneading area c are also collectively referred to as a first extruder, and the heating area d is referred to as a second extruder. In the present embodiment, the mixed, melted, and kneaded raw materials are extruded into the second extruder by the first extruder, and the foam sheet is extruded and foamed by the second extruder. For example, a circular die may be used in the second extruder.

In the present embodiment, the kneading step is performed by the first extruder including the extruding device and the foam sheet forming device, and the below-mentioned foaming step is performed by the second extruder of the foam sheet forming device. However, the present disclosure is not limited to such a configuration. For example, the areas where the kneading step and the foaming step are performed may be appropriately changed.

### <Foaming Step>

The foaming step is a step including removing the compressive fluid to foam the composition (i.e., the polylactic acid composition).

The compressive fluid can be removed by releasing the pressure. A temperature during the foaming step is preferably a temperature higher than the melting point of the polylactic acid resin.

In the foaming step, the compressive fluid dissolved in the composition reduces the solubility thereof by reducing the pressure or elevating the temperature to create supersaturation. As a result, foam nuclei is formed at interfaces mainly with filler particles, the compressive fluid dissolved in the composition is dispersed to grow the foam nuclei into cells, to thereby obtain a foam body. Since foaming occurs with the filler as a starting point, a foam sheet having uniform and fine foam can be produced only when the filler is homogeneously dispersed in polylactic acid. Even when the filler is not used, a foam sheet having uniform and fine foam can be produced because a small amount of crystals generated in the kneading area functions substantially as a foaming nucleating agent.

### <Other Steps>

The above-mentioned other steps are not particularly limited as long as the steps are steps performed in production of a typical foam sheet, and may be appropriately selected depending on the intended purpose. Examples of thereof include a forming step for processing into a sheet.

Examples of the forming step include vacuum molding, pressure forming, and press molding. A sheet-formed product is obtained by the forming step.

### EXAMPLES

The present disclosure will be described below by way of Examples. The present disclosure should not be construed as being limited to these Examples.

### Example 1

### <Production of Foam Sheet>

### <<Production of Master Batch>>

By means of the continuous kneader 100 illustrated in FIG. 6, raw materials were mixed and supplied to the melting area a by supplying polylactic acid (LX175, available from Total Corbion PLA, melting point: 155° C.) at the flow rate of 9.7 kg/hr, surface-treated silica (R972, available from NIPPON AEROSIL CO., LTD.) serving as filler at the flow rate of 0.3 kg/hr to achieve the total flow rate of the polylactic acid and the filler of 1.0 kg/hr. Subsequently, carbon dioxide was supplied as a compressive fluid at the flow rate of 1.00 kg/h (equivalent to 10 parts by mass relative to the composition) to the compressive fluid supply area b, and kneading was performed in the kneading area c. As a result, [Polylactic acid composition precursor including 3% by mass of filler] was obtained.

Note that, in connection with the supplied amount of the carbon dioxide, the phrase “relative to the composition” means a total amount of the polylactic acid and the filler.

Subsequently, [Polylactic acid composition precursor including 3% by mass of filler] was extruded in the form of strands in a water bath in the molding area e. After cooling in the water bath, the strands were pelletized by a strand cutter, to thereby obtain a master batch including 3% by mass of filler ([3% by mass filler master batch]) as a composition precursor.

The temperature of each zone was set as follows.
Raw materials mixing-melting area a and compressive fluid supply area b: 190° C.
Kneading area c: 150° C.
Compressive fluid removing area d: 190° C.
Molding area e: 190° C.

The pressure of each zone was set, as follows.
Zone from compressive fluid supply area b to kneading area c: 7.0 MPa.
Compressive fluid removing area d: 0.5 MPa

### <<Production of Foam Sheet>>

By means of a continuous foam sheet forming device 110 illustrated in FIG. 7, [3% by mass filler master batch] was supplied to the raw material mixing-melting area a of the first extruder in a manner that a total of the flow rate was to be 10 kg/hr. As a cross-linking agent, a glycidyl compound (Joncryl ADR4388C, available from BASF) was supplied to the raw material mixing-melting area a of the first extruder at the flow rate of 0.07 kg/hr (equivalent to 0.7% by mass relative to the amount of the organic matter). Subsequently, as a compressive fluid, carbon dioxide was supplied to the compressive fluid supply area b of the first extruder at the flow rate of 0.99 kg/h (equivalent to 10% by mass relative to the polylactic acid). The resultant was mixed, incited, and kneaded, and then supplied to a second extruder.

Subsequently, the resultant was kneaded in the heating area d of the second extruder, to thereby obtain a composition (polylactic acid composition). The composition was then discharged from a circular die having a slit diameter of 70 mm attached at the edge of the second extruder at the ejection amount of 10 kg/h, and the composition was cooled down to a temperature of 130° C. to remove the compressive fluid from the polylactic acid composition, to thereby extrude and foam the composition. The cylindrical polylactic acid-based resin foam sheet extruded and formed was disposed along the cooled mandrel, air was blown onto the outer surface of the foam from an air ring to cool and form, and the resultant was cut open by a cutter knife, to thereby form the foam sheet into a flat sheet. In the manner as described, a foam sheet of Example 1 was obtained.

The temperature of each zone was set as follows.
Raw material mixing-melting area a of first extruder: 190° C.
Compressive fluid supply area b of first extruder: 190° C.
Kneading area c of first extruder: 150° C.
Heating area d of second extruder: 130° C.

As the pressure of each zone, the zone from the compressive fluid supply area b to the kneading area c of the first extruder and the heats g area d of the second extruder were set to 7.0 MPa.

The physical properties of the obtained foam sheet are presented in Table 1. In Table 1, the proportion of the polylactic acid and the proportion of the cross-linking agent in the organic manner are based on the formula above. Namely, each proportion thereof was calculated from the proportions of the materials added.

### Example 2

A foam sheet of Example 2 was produced in the same manner as in Example 1, provided that [3% by mass filler master batch] was supplied at the flow rate of 0.03 kg/hr and polylactic acid (LX175, available from Total Corbion PLA, melting point: 155° C.) was supplied at the flow rate of 9.97 kg/hr by means of the continuous foam sheet forming device 110 illustrated in FIG. 7 so that the amount of the filler was to be 0.1% by mass relative to the polylactic acid, and the cross-linking agent was not added.

### Example 3

A foam sheet of Example 3 was produced in the same manner as in Example 1, provided that [3% by mass filler master batch] was supplied at the flow rate of 1.67 kg/hr and polylactic acid (LX175, available from Total Corbion PLA, inciting point: 155° C.) was supplied at the flow rate of 8.33 kg/hr by means of the continuous foam sheet forming device 110 illustrated in FIG. 7 so that the amount of the filler was to be 0.5% by mass relative to the polylactic acid, and carbon dioxide was supplied at the flow rate of 1.46 kg/h (equivalent to 14.6 parts by mass relative to the composition).

### Example 4

A foam sheet of Example 4 was produced in the same manner as in Example 3, except that the polylactic acid in the production of the master batch was changed to Revode110 (available from HISUN, melting point: 160° C.), and in the production of the foam sheet, carbon dioxide was supplied at the flow rate of 1.00 kg/h (equivalent to 10 parts by mass relative to the composition), and the temperature of the heating area d of the second extruder was changed to 140° C.

### Example 5

A foam sheet of Example 5 was produced in the same manner as in Example 4, except that in the production of the foam sheet, the temperature of the heating area d of the second extruder was changed to 120° C.

### Example 6

A foam sheet of Example 6 was produced in the same manner as in Example 5, except that, in the production of the foam sheet, the amount of the filler was changed to 0.25% by mass, the total flow rate of the master batch and the polylactic acid was changed to 8 kg/hr, the flow rate of carbon dioxide was changed to 0.80 kg/hr, and the temperature of the heating area d of the second extruder was changed to 155° C.

### Example 7

A foam sheet of Example 7 was produced in the same manner as in Example 4, except that, in the production of the foam sheet, the flow rate of the cross-linking agent was changed to 1.3 kg/hr, and the temperature in the heating area d of the second extruder was changed to 155° C.

### Example 8

A foam sheet of Example 8 was produced in the same manner as in Example 1, except that, in the production of the master batch, the filler for use was changed to UFP-35, available from Denka Company Limited.

### Example 9

A foam sheet of Example 9 was obtained in the same manner as in Example 5, except that, in the production of the master batch, the polylactic acid was changed to LX930 (available from Total Corbion PLA, melting point: 130° C.), and the production of the foam sheet, the temperature of the heating area d of the second extruder was changed to 110° C.

### Comparative Example 1

A foam sheet of Comparative Example 1 was produced in the same manner as in Example 1, except that the polylactic acid was changed to LX975 (available from Total Corbion PLA).

### Comparative Example 2

A foam sheet of Comparative Example 2 was produced in the same manner as in Example 4, except that, in the production of the foam sheet, a temperature and pressure of each zone were changed as follows.

A temperature of each zone was as follows.
Raw materials mixing-melting area a of first, extruder: 180° C.
Compressive fluid supply area b of first extruder: 180° C.
Kneading area c of first extruder: 160° C.
Heating area d of second extruder: 150° C.

As the pressure of each zone, the zone from the compressive fluid supply area b to the kneading area c of the first extruder, and the heating is area d of the second extruder were set to 7.0 MPa.

### Comparative Example 3

A biaxial extruder (“PCM-30” available from IKEGAI, die diameter: 4 mm×3 holes) was used, a temperature of the extruder head was set to 230° C., and a temperature of the die outlet was set to 210° C. Then, polylactic acid (8052D, available from Nature Works LLC) was supplied. Subsequently, 3 parts by mass of an acrylic resin (METABLEN P-501, available from Mitsubishi Chemical Corporation), and 1 part by mass of talc (MW-HST, available from HAYASHI KASEI CO., LTD.) serving as a foam adjusting agent were added relative to 100 parts by mass of the polylactic acid resin. TRIGONOX 301 available from Nouryon (B-1) was added in the middle of the kneader by means of a pump in the manner that the amount of (B-1) was to be 0.5 parts by mass relative to 100 parts by mass of the polylactic acid resin. After the melt-kneading, the kneaded product was extruded, and processed into pellets, to thereby obtain a polylactic acid-based resin composition.

Next, the obtained polylactic acid-based resin composition was supplied to an extrusion foam testing device, which was a biaxial extruder (“PCM-45” available from IKEGAI) equipped with a circle die (diameter: 65 mm, lip width: 0.7 mm) at the edge thereof, 2% by mass of carbon dioxide gas was added at the cylinder temperature of 200° C. and the supply rate of 50 kg/h, to thereby produce a foam sheet of Comparative Example 3.

### (Measurements)

Each of the obtained foam sheets was subjected to measurements of bulk density, the average thickness, the number of cells per 1 mm², the open-cell ratio, the area change rate during heating, change in external appearance (flatness, and downwards bent) after heating, biodegradability, and the volatile component content in the following manner. The measurement results are presented in Tables 1 to 3. Moreover, the amount of polylactic acid relative to the amount of the organic matter in the obtained foam sheet, and the ratio of L-lactic acid were measured and confirmed that the amount thereof and the ratio thereof were identical to the blended amount and ratio.

### <Bulk Density>

The foam sheet, which had been left to stand for 24 hours or longer in the environment having a temperature of 23° C. and relative humidity of 50%, was subjected to a measurement; of bulk density by means of an automatic gravimeter DSG-1, available from Toyo Seiki. Seisaku-sho, Ltd.) according to the in-water weighing method. A weight (g) of the foam sheet in the atmosphere was weighed, and then a weight (g) of the foam sheet in water was weighed, to calculate the bulk density according to the following formula.

Bulk density [g/cm³]=weight of sample in atmosphere [g]/{(weight of sample in atmosphere [g] weight of sample in fluid [g])×density of fluid [g/cm³]}

<Number of Cells Per 1 mm²>

As illustrated in FIG. 2, the obtained foam sheet was cut by a sharp razor blade (76 Razor, available from Nissin EM Co., Ltd.) to expose a cross-section of the foam sheet, and the cross-section of the foam sheet was observed by SEM VE-9800, available from KEYENCE CORPORATION. The obtained 3 cross-section SEM photographs (magnification: 50 times) were binarized into the gray component corresponding to a cell and the resin component (white) using image analysis software (Image-Pro Premier, available from Mediacy), and the number of cells was counted with the Count/Size command. Thereafter, the obtained value was converted into the number of cells in the range of 1 mm×1 mm. In order to evaluate the sheet evenly without variability, the sample was cut in 2 locations separated from each other to expose cross-sections, the number of cells within the range of 1 mm×1 mm was calculated, and then the average of the values obtained from 3 locations was determined to calculate the average number of cells per 1 mm². When the range of 1 mm×1 mm could not be secured within the foam sheet, the maximum square was cut out, the number of cells therein was counted, and then the resultant value was converted into the number of cells per 1 mm×1 mm.

### <Average Thickness>

The average thickness was determined by measuring a thickness at 10 points by means of a caliper (DigiMax Caliper, available from Mitutoyo Corporation), and calculating an average of the measured values.

### <Open-Cell Ratio>

The open-cell ratio was prepared according to ASTM D-2856 in the following manner.

The several number of the foam sheets to achieve a total thickness of about 30 mm were prepared. A thickness thereof was measured by means of a caliper (e.g., DigiMax Caliper, available from Mitutoyo Corporation). The foam sheets were cut into squares having the sides having the same length as the above-mentioned thickness by a sharp razor blade (76 Razor, available from Nissin EM Co., Ltd.) to obtain a cube formed of the stacked foam sheets, where the cube had a side of about 30 mm. A geometric volume of the cube (Vg, the volume including open cells on the cross-sections) was calculated from the size thereof. The sample was measured by a dry automatic pycnometer AccuPyc II 1340, available from Shimadzu Corporation, to determine the sample volume excluding the open cells (Vp1). The cube was cut twice by a sharp knife along the direction vertical to the thickness of the cube, parallel to the side surface, and passing through the centers of the top and bottom surfaces, as illustrated with the broken lines in FIG. 3. The number of cells exposed by the cutting was (the original 4 side surfaces+newly cut 4 surfaces)/the original 4 side surface=2 times. The sample after curing was measured again by AccuPyc II 1340, to thereby determine a sample volume (Vp2).

The open-cell ratio was represented as follows by Formulae (1) to (3) below, where Voc was the volume of the original open cells, and Vcc was the volume of the cells open in the process of the preparation of the sample (originally the closed cells), and as a result, the open-cell ratio was determined.

Vp1=Vg−Voc−Vcc Formula (1)

Vp2=Vg−Voc−2Vcc Formula (2)

Voc=Vg−2Vp1+Vp2 Formula (3)

Open-cell ratio=Voc/Vg×100=(Vg−2Vp1+Vp2)/Vg×100

### <Area Change Rate During Heating>

The area change rate during heating (area change rate before and after the heat storage) was determined as follows. The foam sheet was left, to stand for 24 hours or longer in the environment having a temperature of 23° C. and relative humidity of 50%. The area of the foam sheet having top and bottom surfaces parallel to each other was cut into a square having a length of 15 cm and a width of 15 cm, to thereby prepare a sample. The prepared samples were arranged not to be in contact with each other and stored for 90 minutes in the environment a temperature of which was controlled at 90° C.±2° C. by means of a hot air circulation dryer (e.g., DN-400, available from Yamato Scientific Co., Ltd.). Thereafter, the sample was left, to stand for 1 hour in the environment having a temperature of 23° C., and relative humidity of 50%, and the area was determined. The area change rate was then calculated according to the following equation.

Area change rate={(area before heat storage−area after heat storage)/area before heat storage}×100

### (Evaluations)

The obtained foam sheet was subjected to the following evaluations.

### <Change in External Appearance (Flatness) After Heating>

In the measurement of the area change rate during heating, the external appearance of the sample before and after the heat storage was visually observed.

### [Evaluation Criteria]

A: The sample stayed flat.
B: Only the edge of the sample was slightly curled.
C: The sample was significantly waved or curled, and was not flat.

### <Change in External Appearance (Downward Bent) After Heating>

The evaluation of the degree of downward bent after heating was performed in the following manner. The area of the foam sheet left to stand for 24 hours or longer in the environment having a temperature of 23° C. and relative humidity of 50% in the measurement of the area change rate during heating was cut into two squares each having a length of 15 cm and a width of 15 cm, to thereby prepare 2 samples, where the area was an area of the foam sheet where the top surface and the bottom surface were horizontal to each other. The 2 samples were stored for 90 minute in the environment a temperature of which was adjusted to 90° C.±2° C. using a hot air circulation dryer (DN-400, available from Yamato Scientific Co., Ltd.) in the state where one of the samples was produced from the cuboid platform by 5 cm×15 cm in the length direction and the other sample was produced by 5 cm×15 cm in the width direction. Thereafter, the 2 samples were left to stand on the platform for 1 hour in the environment having a temperature of 23° C. and relative humidity of 50%, and the bent of each of the 2 samples from the edge of the cuboid platform was determined.

When the sample could not be cut out as a square having a side of 15 cm, a sample of the maximum square was cut out, and the samples were projected in the both length direction and the width direction by 1/3 the surface, and heated and stored. Then, the bend was evaluated in the same manner.

### [Evaluation Criteria]

A: The 2 samples were both bent down by less than 2°.
B: The 2 samples were both bent down by less than 5°.
C: At least one of the 2 samples was bent down by 5° or greater.

### <External Appearance of Molded Product After Heat Storage>

The obtained foam sheet was molded to produce the following products.
Small tray in the size of 124 mm×124 mm×17 mm
Large tray in the size of 248 mm×170 min×25 mm.
Fitted lunch box container in the size of 183 mm×135 mm×46 mm

The above-listed samples were left to stand for 24 hours in the environment having a temperature of 23° C., and the relative humidity of 50%, followed by storing the samples placed not to be in contact with each other in the environment a temperature of which was controlled at 90° C.±2° C. by means of a hot air circulation dryer (DN-400, available from Yamato Scientific Co., Ltd.) for 15 minutes. Thereafter, the samples were left to stand in the environment having a temperature of 23° C. and the relative humidity of 50% for 1 hour, followed by being subjected to visual observation.

### [Evaluation Criteria]

4: Any of the molded products was not warped as observed, and the lid of the lunch box fitted to the bottom half of the container.
3: Any of the molded products was not warped significantly as observed, but the lid of the lunch box did not fit to the bottom half of the container.
2: The lunch box container and the large tray were warped, but the small tray was not warped.
1: An of the molded products were significantly deformed.

### <Biodegradability>

The biodegradability was determined according to J1SK6953-2.

### [Evaluation Criteria]

A: The biodegradability was 60% or greater within 45 days.
B: The biodegradability was 60% or greater within 6 months.
C: The biodegradability was less than 60% within 6 months.

### <Volatile Component Content>

The foam sheet was cut into a square having the side of 5 mm to prepare a sample. To 1 part by mass of the sample, 2 parts by mass of 2-propanol was added. The resultant mixture was dispersed by ultrasonic waves for 30 minutes, followed by storing for 1 day in a refrigerator (5° C.) to obtain a volatile component extract. The volatile component extract was analyzed by gas chromatography (GC-14A, available from Shimadzu Corporation) to quantify the volatile component in the foam sheet. The measuring conditions were as follows. When the quantified volatile component was equal to or lower than the detection limit, i.e., the volatile component was not detected in the measurement, the result was determined as “I.” When the volatile component was not detected, the result was determined as “II.”
Device: Shimadzu GC-14A
Column: CBP20-M 50-0.25
Detector: FID
Injection amount: from 1 μL through 5 μL
Carrier gas: He 2.5 kg/cm²
Hydrogen flow rate: 0.6 kg/cm²
Air flow rate: 0.5 kg/cm²
Chart speed: 5 mm/min
Sensitivity: Range 101×Atten 20
Column temperature: 40° C.
Injection Temp: 150° C.

Table 1

| | | Ex. 1 | Ex. 2 | Ex. 3 | Ex. 4 | Ex. 5 | Ex. 6 |
|---|---|---|---|---|---|---|---|
| Polylactic | Polylactic acid | LX175 | LX175 | LX175 | Revode 110 | Revode 110 | Revode 110 |
| acid | (L-lactic acid ratio) | (96%) | (96%) | (96%) | (97%) | (97%) | (97%) |
| | Proportion of | 99.3 | 100 | 99.3 | 99.3 | 99.3 | 99.3 |
| | polylactic acid | | | | | | |
| | in organic | | | | | | |
| | matter (mass %) | | | | | | |
| Filler | Type | Silica | Silica | Silica | Silica | Silica | Silica |
| | Average particle | 0.004 | 0.004 | 0.004 | 0.004 | 0.004 | 0.004 |
| | diameter (μm) | | | | | | |
| | Amount | 3 | 0.1 | 0.5 | 0.5 | 0.25 | 0.25 |
| | (mass %) | | | | | | |
| Cross- | Type | ADR- | — | ADR- | ADR- | ADR- | ADR- |
| linking | | 4368C | | 4368C | 4368C | 4368C | 4368C |
| agent | Proportion of | 0.7 | — | 0.7 | 0.7 | 0.7 | 0.7 |
| | cross-linking | | | | | | |
| | agent in organic | | | | | | |
| | matter (mass %) | | | | | | |
| Physical | Bulk density | 0.046 | 0.313 | 0.060 | 0.156 | 0.037 | 0.192 |
| properties | (g/cm³) | | | | | | |
| of foam | Sheet average | 2.6 | 1.5 | 1.7 | 1.2 | 2.2 | 0.51 |
| sheet | thickness (mm) | | | | | | |
| | The number of | 63 | 44 | 47 | 118 | 984 | 81 |
| | cells (cells/mm²) | | | | | | |
| | Open cell rate | 15 | 18 | 19 | 5 | 4 | 11 |
| | (%) | | | | | | |
| | Area change | 5 | 12 | 9 | 8 | 1 | 5 |
| | rate during | | | | | | |
| | heating (%) | | | | | | |
| Evaluations | External | A | B | B | B | A | B |
| | appearance | | | | | | |
| | after heating | | | | | | |
| | (flatness) | | | | | | |
| | External | A | B | B | B | A | B |
| | appearance | | | | | | |
| | after heating | | | | | | |
| | (downward | | | | | | |
| | bent) | | | | | | |
| | External | 4 | 2 | 3 | 3 | 4 | 4 |
| | appearance of | | | | | | |
| | shaped product | | | | | | |
| | after heat | | | | | | |
| | storage | | | | | | |
| | Biodegradability | A | A | A | A | A | A |
| | Residual | I | I | I | I | I | I |
| | volatile | | | | | | |
| | component | | | | | | |
| | content | | | | | | |

TABLE 2

| | | Ex. 7 | Ex. 8 | Ex. 9 |
|---|---|---|---|---|
| Polylactic | Polylactic acid | Revode 110 | Revode 110 | LX 930 |
| acid | (L-lactic acid ratio) | (97%) | (97%) | (90%) |
| | Proportion of | 98.7 | 99.3 | 99.3 |
| | polylactic acid in | | | |
| | organic matter | | | |
| | (mass %) | | | |
| Filler | Type | Silica | Silica | Silica |
| | Average particle | 0.004 | 0.095 | 0.004 |
| | diameter (μm) | | | |
| | Amount (mass %) | 0.5 | 3 | 0.5 |
| Cross- | Type | ADR- | ADR- | ADR- |
| linking | Proportion of cross- | 4.368C | 4368C | 4368C |
| agent | linking agent in | 1.3 | 0.7 | 0.7 |
| | organic matter | | | |
| | (mass %) | | | |
| Physical | Bulk density (g/cm³) | 0.044 | 0.063 | 0.033 |
| properties | Sheet average | 4.9 | 1.9 | 5.1 |
| of | thickness (mm) | | | |
| foam sheet | The number of cells | 860 | 312 | 645 |
| | (cells/mm²) | | | |
| | Open cell rate (%) | 4 | 17 | 16 |
| | Area change rate | 4 | 15 | 14 |
| | during heating (%) | | | |
| Evalu- | External appearance | A | B | B |
| ations | after heating | | | |
| | (flatness) | | | |
| | External appearance | A | B | A |
| | after heating | | | |
| | (downward bent) | | | |
| | External appearance | 4 | 2 | 2 |
| | of shaped product | | | |
| | after heat storage | | | |
| | Biodegradability | B | A | A |
| | Residual volatile | I | I | I |
| _ | component content | | | |

TABLE 3

| | | Comp. | Comp. | Comp. |
|---|---|---|---|---|
| | | Ex. 1 | Ex. 2 | Ex. 3 |
| Polylactic | Polylactic acid | LX 975 | LX 975 | 8052D |
| acid | (L-lactic acid ratio) | (88%) | (96%) | (95.5%) |
| | Proportion of | 99.3 | 99.3 | 96.6 |
| | polylactic acid in | | | |
| | organic matter | | | |
| | (mass %) | | | |
| Filler | Type | Silica | Silica | Talc |
| | Average particle | 0.004 | 0.004 | 2.5 |
| | diameter (μm) | | | |
| | Amount (mass %) | 3 | 0.5 | 1 |
| Cross- | Type | ADR- | ADR- | TRIGO- |
| linking | Proportion of cross- | 4368C | 4368C | NOX 301 |
| agent | linking agent in | 0.7 | 0.7 | 0.5 |
| | organic matter | | | |
| | (mass %) | | | |
| Physical | Bulk density (g/cm³) | 0.031 | 0.568 | 0.110 |
| properties | Sheet average | 5.2 | 0.4 | 1.6 |
| of | thickness (mm) | | | |
| foam sheet | The number of cells | 680 | 64 | 7 |
| | (cells/mm²) | | | |
| | Open cell rate (%) | 14 | 38 | 3 |
| | Area change rate | 16 | 2 | 2.3 |
| | during heating (%) | | | |
| Evalu- | External appearance | B | C | A |
| ations | after heating | | | |
| | (flatness) | | | |
| | External appearance | B | C | B |
| | after heating | | | |
| | (downward bent) | | | |
| | External appearance | 1 | 4 | 4 |
| | of shaped product | | | |
| | after heat storage | | | |
| | Biodegradability | B | B | C |
| | Residual volatile | I | I | I |
| | component content | | | |

As presented above, it was found that the foam sheets having excellent biodegradability and excellent external appearance at high temperatures in Examples, In Tables 1 to 3, the absolute values are presented as the values of the area change rate during heating, The value thereof of 15 or less indicates excellent size stability at high temperatures. The value thereof 10 or less indicates more excellent size stability at high temperatures.

What is claimed is:

1. A foam sheet comprising:
a composition including polylactic acid,
wherein the polylactic acid includes, as monomer units, D-lactic acid and L-lactic acid, and an amount of the D-lactic acid or the L-lactic acid in the polylactic acid is 90 mol % or greater but less than 98 mol %,
an amount of the polylactic acid is 97% by mass or greater relative to a total amount of organic matter in the foam sheet,
when the foam sheet is cut into a square test piece, and the square test piece is heated and stored for 90 minutes in a hot air circulation dryer a temperature of which is maintained at 90° C.±2° C., a rate of change in an area of the square test piece before and after heat storage is within ±15%, and
an average thickness of the foam sheet is 0.5 mm or greater.

2. The foam sheet according to claim 1,
wherein bulk density of the foam sheet is 0.025 g/cm³ or greater but 0.125 g/cm³ or less.

3. The foam sheet according to claim 1,
wherein number of cells per 1 mm² of the foam sheet is 50 or greater.

4. The foam sheet according to claim 1,
wherein an open-cell ratio of the foam sheet is 20% or less.

5. The foam sheet according to claim 1,
wherein the foam sheet further comprises filler in an amount of 3% by mass or less.

6. The foam sheet according to claim 5,
wherein a number average particle diameter of the filler is 4 nm or greater but 100 nm or less.

7. The foam sheet according to claim 1,
wherein the amount of the D-lactic acid or the L-lactic acid in the polylactic acid is 94 mol % or greater but less than 98 mol %.

8. The foam sheet according to claim 1,
wherein the rate of change in the area of the square test piece before and after the heat storage is within ±10%.

9. The foam sheet according to claim 1,
wherein the average thickness of the foam sheet is 10 mm or less.

10. The foam sheet according to claim 1,
wherein the average thickness of the foam sheet is 0.5 mm or greater but 5 mm or less.

11. The foam sheet according to claim 1,
wherein an organic compound having a boiling point of −20° C. or higher but 150° C. or lower is not detected when the foam sheet is subjected to the following measurement:
[Measurement]
part of the foam sheet is dispersed in a solvent to prepare a dispersion liquid, and a supernatant liquid of the dispersion liquid is measured by gas chromatography to quantify the organic compound.

12. A product comprising
the foam sheet according to claim 1.

13. The product according to claim 12,
wherein the product is at least one selected from the group consisting of a bag, a packaging container, tableware, cutlery, stationary, and a buffer material.

14. A method for producing a foam sheet, the method comprising:
kneading polylactic acid and filler in presence of a compressive fluid at a temperature lower than a melting point of the polylactic acid to obtain a composition; and
removing the compressive fluid to foam the composition, to thereby produce the foam sheet.

15. The method according to claim 14,
wherein the foam sheet is the foam sheet according to claim 1.

16. The method according to claim 14,
wherein the compressive fluid is carbon dioxide.

17. The method according to claim 14,
wherein the kneading includes kneading the polylactic acid, the filler, and a cross-linking agent.

18. The method according to claim 17,
wherein the cross-linking agent is an epoxy-based cross-linking agent.
